(19) United States
(12) Patent Application Publication
(10) Pub. No.: US 2024/0243394 A1
(43) Pub. Date: Jul. 18, 2024

(54) PACKAGING MATERIAL, CASE, AND POWER STORAGE DEVICE

(71) Applicant: SHOWA DENKO PACKAGING CO., LTD., Kanagawa (JP)

(72) Inventors: Wei HE, Kanagawa (JP); Hiroaki ITO, Kanagawa (JP); Takashi NAGAOKA, Kanagawa (JP); Makoto KARATSU, Kanagawa (JP)

(73) Assignee: SHOWA DENKO PACKAGING CO., LTD., Kanagawa (JP)

(21) Appl. No.: 18/585,881

(22) Filed: Feb. 23, 2024

Related U.S. Application Data
(63) Continuation of application No. 15/287,882, filed on Oct. 7, 2016, now abandoned.

(30) Foreign Application Priority Data
Oct. 7, 2015 (JP) 2015-199410

(51) Int. Cl. H01M 50/124; B32B 1/08; B32B 7/027; B32B 7/12; B32B 15/082; B32B 15/085; B32B 15/088; B32B 15/09; B32B 15/20; B32B 27/06; B32B 27/16; B32B 27/30; B32B 27/32; B32B 27/34; B32B 27/36; B32B 37/02; B32B 37/06; B32B 37/12; B32B 37/24; H01M 10/052; H01M 10/0525; H01M 50/119; H01M 50/121; H01M 50/129; H01M 50/131

(52) U.S. Cl. CPC H01M 50/124; B32B 1/08; B32B 7/027; B32B 7/12; B32B 15/082; B32B 15/085; B32B 15/088; B32B 15/09; B32B 15/20; B32B 27/06; B32B 27/16; B32B 27/306; B32B 27/308; B32B 27/32; B32B 27/34; B32B 27/36; B32B 37/02; B32B 37/06; B32B 37/12; H01M 10/0525; H01M 50/119; H01M 50/121; H01M 50/129; H01M 50/131; B32B 2037/1253; B32B 2037/243; B32B 2250/03; B32B 2250/40; B32B 2255/10; B32B 2255/26; B32B 2307/306; B32B 2307/31; B32B 2307/50; B32B 2307/518; B32B 2307/54; B32B 2307/714; B32B 2307/7244; B32B 2307/7246; B32B 2307/732; B32B 2307/736; B32B 2307/738; B32B 2309/02; B32B 2309/105; B32B 2311/24; B32B 2333/04; B32B 2375/00; B32B 2377/00; B32B 2439/00; B32B 2439/70; B32B 2439/80; B32B 2457/10; B32B 2553/00; B32B 2605/00; H01M 10/052; H01M 2220/10; H01M 2220/20; H01M 2220/30

(57) ABSTRACT

The packaging material includes a heat-resistant resin layer 2 as an outer side layer, a heat-fusible resin layer 3 as an inner side layer, and a metal foil layer 4 arranged between these layers. The heat-resistant resin layer 2 is made of a heat-resistant resin film having a hot water shrinkage rate of 1.5% to 12% and the heat-resistant resin layer 2 and the metal foil layer 4 are adhered via an outer side adhesive layer 5. The adhesive layer 5 is formed by an urethane adhesive agent containing a polyol, a polyfunctional isocyanate compound, and an aliphatic compound containing a plurality of functional groups capable of reacting with an isocyanate group in one molecule. With this, a packaging material can be provided in which excellent formability can be secured and delamination can be sufficiently suppressed without causing pinholes, etc., even when deep depth drawing is performed.

### CROSS-REFERENCE TO THE RELATED APPLICATIONS

The present application claims priority to Japanese Patent Application No. 2015-199410 filed on Oct. 7, 2015, the entire disclosure of which is incorporated herein by reference in its entirety.

### BACKGROUND OF THE INVENTION

### Technical Field

The present invention relates to, for example, a packaging material (exterior material) for a power storage device, such as a secondary battery (e.g., a lithium-ion secondary battery, etc.), a packaging material suitably used as a case. It also relates to a case, a packaging material suitably used as a packaging material for foods or pharmaceutical products, and a power storage device packaged by the packaging material and/or the case described above.

In this specification and claims, the term “aluminum” is used to include the meaning of aluminum and its alloys.

### Description of the Related Art

The following description of the related art sets forth the inventors' knowledge of the related art and certain problems therein and should not be construed as an admission of knowledge in the prior art.

A lithium-ion secondary battery is widely used as a power source for, e.g., laptop computers, video cameras, mobile phones, electric cars, etc. The lithium-ion secondary battery having a configuration in which the perimeter of the battery main body (the main body including a positive electrode, a negative electrode, and electrolyte) is surrounded by a case is used. As the case material (external material or armoring material), a configuration in which an outer side layer made of a heat-resistant resin film, an aluminum foil layer, and an inner side layer made of a thermoplastic resin film are integrally adhered in that order is well-known.

For example, a packaging material which is a laminated type packaging material is known in which an inner side layer made of a resin film, and a first adhesive layer, a metal layer, a second adhesive layer, and an outer side layer made of a resin film are laminated, and at least one of the first adhesive layer and the second adhesive layer is made of an adhesive agent composition having a resin containing an active hydrogen group in a side chain, a polyfunctional isocyanate group, and a polyfunctional amine compound as essential components (see Patent Document 1: Japanese Unexamined Patent Application Publication No. 2008-287971).

Furthermore, a battery case packaging material using a polyamide film or a polyester film is known in which a polyamide film or a polyester film having a thickness of 9 to 50 μm is laminated on at least one surface of an aluminum foil, and a film comprised of polypropylene, maleic modified polypropylene, an ethylene-acrylate copolymer, or an ionomer resin is laminated on the outermost side, and the tensile strength of a polyamide film or a polyester film in a tension test in four directions (0°, 45°, 90°, and 135°) until breaking is 150 N/mm² or more and the stretch in the four directions is 80% or more (see Patent Document 2: Japanese Unexamined Patent Application Publication No. 2000-123800).

However, in the technology described in the aforementioned Patent Documents 1 and 2, both sufficient heat-resistance and excellent formability for a packaging material could not be obtained.

Further, in the packaging material described in Patent Document 1, delamination (detachment) tends to occur between the metal foil layer and the outer resin layer when deep depth molding (molding in which its molding depth is deep) is performed, and delamination tends to occur between the metal foil layer and the outer resin layer when used under a harsh environment, such as, e.g., a hot and humid environment.

Furthermore, in the packaging material described in Patent Document 2, there is a problem that pinholes and/or cracks tend to occur when deep depth molding (molding in which its molding depth is deep) is performed since stress is concentrated on a portion of the metal foil.

The description herein of advantages and disadvantages of various features, embodiments, methods, and apparatus disclosed in other publications is in no way intended to limit the present disclosure. For example, certain features of the preferred described embodiments of the disclosure may be capable of overcoming certain disadvantages and/or providing certain advantages, such as, e.g., disadvantages and/or advantages discussed herein, while retaining some or all of the features, embodiments, methods, and apparatus disclosed therein.

### SUMMARY OF THE INVENTION

Some embodiments in this disclosure have been developed in view of the above-mentioned and/or other problems in the related art. The embodiments in this disclosure can significantly improve upon existing methods and/or apparatuses.

The present invention was made in view of the aforementioned technical background, and aims to provide a packaging material and a case having a heat-resistance and capable of securing excellent formability without causing pinholes and/or cracks even when deep depth molding (molding in which its molding depth is deep) is performed and sufficiently preventing delamination (detachment) even when used under a harsh environment, such as, e.g., a hot and humid environment. Further, the present invention also aims to provide a power storage device armored by such a packaging material and/or a case.

The other purposes and advantages of some embodiments of the present disclosure will be made apparent from the following preferred embodiments.

To achieve the aforementioned objects, the present invention provides the following means.

[1] A packaging material including:
a heat-resistant resin layer as an outer side layer;
a heat-fusible resin layer as an inner side layer; and
a metal foil layer arranged between the heat-resistant resin layer and the heat-fusible resin layer;
wherein the heat-resistant resin layer is made of a heat-resistant resin film having a hot water shrinkage rate of 1.5% to 12%,
wherein the heat-resistant resin layer and the metal foil layer are adhered via an outer side adhesive layer, and
wherein the outer side adhesive layer is made of an urethane adhesive agent containing a polyol, a polyfunctional isocyanate compound, and an aliphatic compound having a plurality of functional groups capable of reacting with an isocyanate group in one molecule.

[2] The packaging material as recited in the aforementioned Item [1], wherein the polyol is a polyester polyol.

[3] The packaging material as recited in the aforementioned Item [2],
wherein the polyester polyol includes a dicarboxylic acid component, and
wherein the dicarboxylic acid component contains an aromatic dicarboxylic acid, and a content rate of the aromatic dicarboxylic acid in the dicarboxylic acid component is 40 mol % to 80 mol %.

[4] The packaging material as recited in any one of the aforementioned Items [1] to [3], wherein the aliphatic compound is a polyhydric alcohol.

[5] The packaging material as recited in any one of the aforementioned Items [1] to [4], wherein the outer side adhesive layer includes at least one type of bond selected from the group consisting of an urethane bond, an ester bond, an urea bond, an allophanate bond, a burette bond, and an amide bond.

[6] The packaging material as recited in any one of the aforementioned Items [1] to [5], wherein an easily adhesive layer is arranged between the heat-resistant resin layer and the outer side adhesive layer.

[7] The packaging material as recited in the aforementioned Item [6], wherein the easily adhesive layer contains one or two or more types of resins selected from the group consisting of an epoxy resin, an urethane resin, an acrylic ester resin, a methacrylic ester resin, and a polyethylenimine resin.

[8] The print medium as recited in any one of the aforementioned Items [1] to [7], wherein a Young's modulus of a cured film of the urethane adhesive agent is 90 MPa to 400 MPa.

[9] A case made by a molded body of the packaging material as recited in any one of the aforementioned Items [1] to [8].

[10] A method for producing a case in which the packaging material as recited in any one of the aforementioned Items [1] to [8] is subjected to deep-drawing or bulging.

[11] A power storage device including:
a power storage device main body; and
an exterior material consisting of the packaging material as recited in any one of the aforementioned Items [1] to [8] and/or the case as recited in the aforementioned Item [9],
wherein the power storage device main body is armored by the exterior material.

[12] A method for producing a packaging material, including:
a step of preparing a laminated product comprising a heat-resistant resin layer as an outer side layer, a heat-fusible resin layer as an inner side layer, and a metal foil layer arranged between the heat-resistant resin layer and the heat-fusible resin layer, wherein the heat-resistant resin layer is made of a heat-resistant resin film having a hot water shrinkage rate of 1.5% to 12%, wherein the heat-fusible resin layer and the metal foil layer are adhered via a curing type inner side adhesive agent, and wherein the heat-resistant resin layer and the metal foil layer are adhered via a curing type outer side adhesive agent containing a polyol, a polyfunctional isocyanate compound, and an aliphatic compound having a plurality of functional groups capable of reacting with an isocyanate group in one molecule; and
an aging processing step for curing the curing type inner side adhesive agent and the curing type outer side adhesive agent by subjecting the laminated product to heat aging processing at a temperature in a range of 37° C. to 55° c.

[13] The method for producing a packaging material as recited in the aforementioned Item [12], wherein the curing type inner side adhesive agent is a thermosetting type acrylic adhesive agent.

According to the invention as recited in the aforementioned Item [1], the heat-resistant resin layer as the outer side layer is made of a heat-resistant resin film having a hot water shrinkage rate of 1.5% to 12%, so the stress concentration from cold (room temperature) drawing, such as, e.g., deep drawing and bulging, can be suppressed. With this, excellent formability can be obtained without causing pinholes and/or cracks even when performing molding deep in depth.

Further, since the heat-resistant resin layer and the metal foil layer are configured to be adhered to each other via an urethane adhesive agent containing a polyol, a polyfunctional isocyanate compound, and an aliphatic compound having a plurality of functional groups capable of reacting with an isocyanate group in one molecule, the heat-resistance of the packaging material can be improved.

Furthermore, i) the heat-resistant resin layer (outer side layer) is configured to be formed by a heat-resistant resin film having a hot water shrinkage rate of 1.5% to 12%, and ii) the heat-resistant resin layer and the metal foil layer are configured to be adhered to each other via an urethane adhesive agent containing a polyol, a polyfunctional isocyanate compound, and an aliphatic compound having a plurality of functional groups capable of reacting with an isocyanate group in one molecule, that is, configured with both the configurations of i) and ii). Therefore, delamination (detachment) can be sufficiently prevented even when performing deep depth molding (molding in which its molding depth is deep), or even when used under a harsh environment, such as, e.g., hot and humid environment.

In addition, since an urethane adhesive agent containing a polyol, a polyfunctional isocyanate compound, and an aliphatic compound having a plurality of functional groups capable of reacting with an isocyanate group in one molecule is used as the outer side adhesive agentouter side adhesive agent, the curing reaction can be facilitated at a lower temperature than a conventional adhesive agent.

Conventionally, in general, a relationship in which the most suitable aging temperature (temperature at which the curing reaction is facilitated) of the heat-resistant resin layer side adhesive agent (outer side adhesive agent) is higher than the most suitable aging temperature (the temperature at which the curing reaction is facilitated) of the heat-fusible resin layer side adhesive agent (inner side adhesive agent) is more likely. In such a case, the productivity was poor since first aging processing for the curing reaction of the inner side adhesive agent and second aging processing for the curing reaction of the outer side adhesive agent had to be performed separately, i.e., in two parts. In the present invention, since an urethane adhesive agent containing a polyol, a polyfunctional isocyanate compound, and an aliphatic compound having a plurality of functional groups capable of reacting with an isocyanate group in one molecule is used as the outer side adhesive agent, the curing progresses at a lower temperature than a conventional adhesive agent, which enables the aging processing of the inner side adhesive agent and the outer side adhesive agent to be performed together simultaneously in one aging process, so there is an advantage that the lead time (time needed from material input to when the product is completed) can be shortened. Further, the invention as recited in the aforementioned Item is a method of producing a packaging material by subjecting the curing type inner side adhesive agent and the curing type outer side adhesive agent together simultaneously to an aging process in one such aging process.

According to the invention as recited in the aforementioned Item [2], since the lead time can be further shortened, the cost can be reduced.

According to the invention as recited in the aforementioned Item [3], the polyester polyol includes a dicarboxylic acid component, and since the content rate of the aromatic dicarboxylic acid in the dicarboxylic acid component is 40 mol % to 80 mol % and includes 40 mol % to 80 mol % of the aromatic dicarboxylic acid, the framework of the main agent (polyester polyol) becomes hard, thereby improving the heat-resistance, and the adhesive strength of the outer side adhesive layer increases, thereby improving the formability. Therefore, even when deep depth molding (molding in which its molding depth is deep) is performed, the delamination (detachment) between the outer side layer and the metal foil layer can be sufficiently prevented.

According to the invention as recited in the aforementioned Item [4], since a polyhydric alcohol is used as the aliphatic compound, even when performing deep depth molding (molding in which its molding depth is deep), delamination between the outer side layer and the metal foil layer can be sufficiently prevented.

According to the invention as recited in the aforementioned Item [5], since the outer side adhesive layer includes at least one type of bond selected from the group consisting of an urethane bond, an ester bond, an urea bond, an allophanate bond, a burette bond, and an amide bond, the adhesive strength of the outer side adhesive layer increases and the formability can be improved. Therefore, even when performing deep depth molding (molding in which its molding depth is deep), the delamination (detachment) between the outer side layer and the metal foil layer can be sufficiently prevented.

According to the invention as recited in the aforementioned Item [6], since an easily adhesive layer is arranged between the heat-resistant resin layer and the outer side adhesive layer, even when used under a harsh environment, such as, e.g., hot and humid environment, delamination between the outer side layer and the metal foil layer can be sufficiently prevented.

According to the invention as recited in the aforementioned Item [7], since an easily adhesive layer has a configuration containing the above-specified resins, even when used under a harsh environment, such as, e.g., a hot and humid environment, delamination between the outer side layer and the metal foil layer can be sufficiently prevented.

According to the invention as recited in the aforementioned Item [8], since a configuration in which the Young's modulus of the cured film of the urethane adhesive agent is 90 MPa to 400 MPa, the formability can be further improved and the durability of the outer side adhesive layer can be improved.

According to the invention as recited in the aforementioned Item [9], a case having a heat-resistance and capable of obtaining excellent formability in which pinholes and/or cracks do not occur even when performing deep depth molding (molding in which its molding depth is deep) and in which delamination can be sufficiently prevented even when used under a harsh environment, such as, e.g., a hot and humid environment, is provided.

According to the invention as recited in the aforementioned Item [10], a case having a heat-resistance and capable of obtaining excellent formability in which pinholes and/or cracks do not occur even when deep depth molding (molding in which its molding depth is deep) is performed and in which delamination can be sufficiently prevented when used under a harsh environment, such as, e.g., a hot and humid environment, can be produced.

According to the invention as recited in the aforementioned Item [11], a power storage device having a heat-resistant and no pinholes and/or cracks, and armored with the exterior material capable of sufficiently preventing delamination even when used under a harsh environment, such as, e.g., a hot and humid environment can be provided.

According to the invention (production method) as recited in the aforementioned Item [12], a packaging material having a heat-resistance and capable of obtaining excellent formability in which pinholes and/or cracks do not occur even when performing deep depth molding (molding in which its molding depth is deep) and in which delamination can be sufficiently prevented when used under a harsh environment, such as, e.g., a hot and humid environment, can be produced.

Further, a curing type outer side adhesive agent containing a polyol, a polyfunctional isocyanate compound, and an aliphatic compound having a plurality of functional groups capable of reacting with an isocyanate group in one molecule is used as the outer side adhesive agent, and the curing type outer side adhesive agent is capable of facilitating the curing reaction in a temperature range of 37° C. to 55° C. which is lower than a conventional temperature. Therefore, since both adhesive agents, the curing type inner side adhesive agent and the curing type outer side adhesive agent, can be cured by being subjected to aging together simultaneously, there is an advantage that the productivity can be significantly improved.

According to the invention as recited in the aforementioned Item [13], since the thermosetting type acrylic adhesive agent is used as the curing type inner side adhesive agent, the conformity of the temperature range in which the curing reaction is facilitated between the curing type inner side adhesive agent and the curing type outer side adhesive agent is high. Therefore, the aging processing time can be shortened and the productivity can be further improved.

### BRIEF DESCRIPTION OF THE DRAWINGS

Some embodiments of the present disclosure are shown by way of example, and not limitation, in the accompanying figures.

FIG. 1 is a cross-sectional view of an embodiment of a packaging material according to the present invention.

FIG. 2 is a cross-sectional view of another embodiment of a packaging material according to the present invention.

FIG. 3 is a cross-sectional view of an embodiment of a power storage device according to the present invention.

FIG. 4 is a perspective view showing a packaging material (planar shape), a power storage device main body, and a case (molded body molded in a three-dimensional shape) in an exploded state before being heat-sealed.

### EMBODIMENTS FOR CARRYING OUT THE INVENTION

In the following paragraphs, some embodiments in the present disclosure will be described by way of example and not limitation. It should be understood based on this disclosure that various other modifications can be made by those in the art based on these illustrated embodiments.

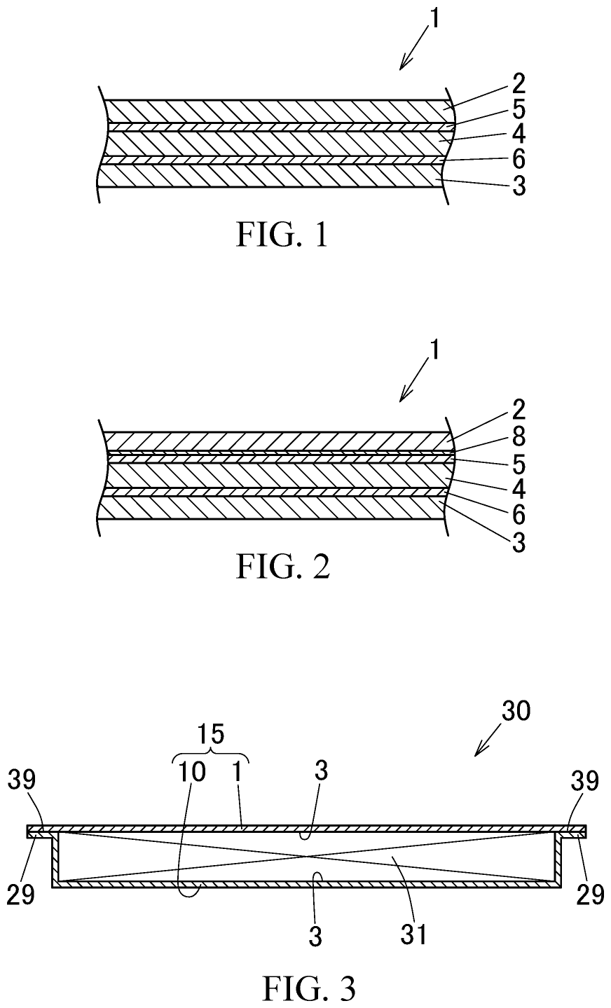

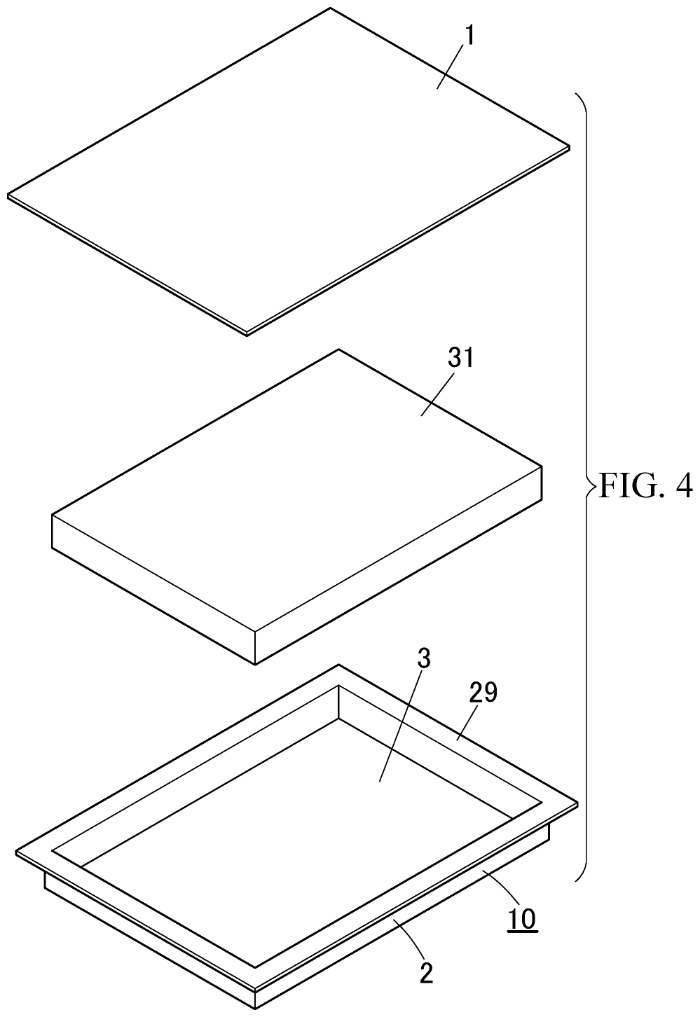

An embodiment of a packaging material 1 according to the present invention is shown in FIG. 1. The packaging material 1 is used as a battery packaging material for a lithium-ion secondary battery, etc. The packaging material 1 can be used as a packaging material 1 as it is without being subjected to molding (see FIG. 4). For example, it can be subjected to molding, such as, e.g., deep drawing and bulging, and used as a molded case 10 (see FIG. 4).

The molding packaging material 1 has a structure in which a heat-resistant resin layer (outer side layer) 2 is integrally laminated on one of the surfaces (upper surface) of a metal foil layer 4 via an outer side adhesive layer (first adhesive layer) 5, and a heat-fusible resin layer (inner side layer) 3 is integrally laminated on the other surface (lower surface) of the metal foil layer 4 via an inner adhesive layer (second adhesive layer) 6 (see FIG. 1).

Another embodiment of a packaging material 1 according to the present invention is shown in FIG. 2. This packaging material 1 has a structure in which a heat-resistant resin layer (outer side layer) 2 is integrally laminated on one of surfaces (upper surface) of a metal foil layer 4 via an outer side adhesive layer (first adhesive layer) 5, and a heat-fusible resin layer (inner side layer) 3 is integrally laminated on the other surface (lower surface) of the metal foil layer 4 via an inner adhesive layer (second adhesive layer) 6. Furthermore, an easily adhesive layer 8 is laminated on the lower surface of the heat-resistant resin layer (outer side layer) 2, and the outer side adhesive layer (first adhesive layer) 5 is laminated on the lower surface of the easily adhesive layer 8. That is, it is a laminated structure of the heat-resistant resin layer (outer side layer) 2/the easily adhesive layer 8/the outer side adhesive layer 5/the metal foil layer 4/the inner adhesive layer 6/the heat-fusible resin layer (inner side layer) 3 (see FIG. 2). In this embodiment, the easily adhesive layer 8 is laminated on the lower surface of the heat-resistant resin layer 2 by a gravure coating method.

In the present invention, the outer side layer 2 is formed by a heat-resistant resin layer. As the heat-resistant resin constituting the heat-resistant resin layer 2, a heat-resistant resin that does not melt at the heat-sealing temperature when heat-sealing the packaging material 1 is used. As the heat-resistant resin, it is preferable to use a heat-resistant resin having a melting point higher than the melting point of the heat-fusible resin constituting the heat-fusible resin layer 3 by 10ºC or more, and especially preferable to use a heat-resistant resin having a melting point higher than the melting point of the heat-fusible resin by 20° C. or more.

The heat-resistant resin layer (outer side layer) 2 is a member which mainly plays a role of obtaining excellent formability as the packaging material 1, that is, it mainly plays a role of preventing breaking of the aluminum foil due to necking at the time of molding.

In the present invention, the heat-resistant resin layer 2 is required to be constituted by a heat-resistant resin film having a hot water shrinkage rate of 1.5% to 12%. When the hot water shrinkage rate is less than 1.5%, there is a problem that breakage and/or cracking tends to occur at the time of molding. On the other hand, when the hot water shrinkage rate exceeds 12%, delamination (detachment) tends to occur between the outer side layer 2 and the metal foil layer 4. In particular, it is preferable to use a heat-resistant resin film having a hot water shrinkage rate of 1.8% to 11% as the heat-resistant resin film. Furthermore, it is more preferable to use a heat-resistant resin film having a hot water shrinkage rate of 1.8% to 6% as the heat-resistant resin film. As the heat-resistant resin film, it is preferable to use a heat-resistant resin stretched film.

The “hot water shrinkage rate” denotes a dimensional change rate of a test piece (10 cm×10 cm) of the heat-resistant resin stretched film 2 in the stretched direction before and after immersion of the test piece in hot water at 95° C. for 30 minutes, and can be calculated by the following formula.

$$Hot water shrinkage rate ( \% ) = \{ ( X - Y ) / X \} \times 100$$

X: dimension in the stretched direction before the immersion treatment
Y: dimension in the stretched direction after the immersion treatment

The hot water shrinkage rate in the case of using a biaxially stretched film is an average value of the dimensional change rate in the two stretched directions.

The hot water shrinkage rate of the heat-resistant resin stretched film can be, for example, controlled by adjusting the heat setting temperature at the time of the stretching process.

As the heat-resistant resin layer (outer side layer) 2, although not especially limited, for example, a stretched polyamide film, such as, e.g., a stretched nylon film, and a stretched polyester film, etc., can be exemplified. In particular, as the heat-resistant resin layer 2, it is especially preferable that a biaxially stretched polyamide film, such as, e.g., a biaxially stretched nylon film, a biaxially stretched polybutylene terephthalate (PBT) film, a biaxially stretched polyethylene terephthalate (PET) film, or a biaxially stretched polyethylene naphthalate (PEN) film having a hot water shrinkage rate of 1.5% to 12% be used. Further, as the heat-resistant resin layer 2, it is preferable to use a heat-resistant resin biaxially stretched film stretched by a simultaneous biaxial stretching method. As the nylon, although not especially limited, for example, 6-nylon, 6,6-nylon, MXD nylon, etc., can be exemplified. The heat-resistant resin film layer 2 may be formed as a single layer (single stretched film), or it may be formed in, for example, a multiple layer (multiple layer made of PET film/stretched nylon film, etc.) made of a stretched polyester film/stretched polyamide film.

It is preferable that the thickness of the heat-resistant resin layer 2 be 12 μm to 50 μm. By setting the thickness to be equal to or greater than the preferred lower limit, a sufficient strength as a packaging material can be obtained. By setting the thickness to be equal to or smaller than the preferred upper limit, the stress at the time of bulging or drawing molding can be reduced, which in turn can improve the formability.

It is preferable that the easily adhesive layer 8 be laminated on the inner surface (the metal foil layer 4 side surface) of the heat-resistant resin layer 2. By coating the inner surface (the metal foil layer 4 side surface) of the heat-resistant resin layer 2 with a polar resin, etc., having excellent close-fitness and stickiness and adhesiveness to laminate the easily adhesive layer 8, the cohesiveness and adhesiveness to the outer side adhesive layer 5 can be improved, and therefore the cohesiveness and adhesiveness between the heat-resistant resin layer 2 and the metal foil layer 4 can be improved. Further, it is preferable that the inner surface (surface to which the easily adhesive layer 8 is laminated) of the heat-resistant resin layer 2 be subjected to corona processing, etc., in advance before laminating the easily adhesive layer 8 to increase the wettability.

The method of forming the easily adhesive layer 8 is not specifically limited, but the easily adhesive layer can be formed by applying an aqueous emulsion (water-based emulsion) made of one, or two or more types of resins selected from the group consisting of an epoxy resin, an urethane resin, an acrylic ester resin, a methacrylic ester resin, and a polyethylenimine resin and drying it. As the coating method, although not especially limited, for example, a spray coating method, a gravure roll coating method, a reverse roll coating method, a lip coating method, etc., can be exemplified.

Thus, it is preferable that the easily adhesive layer 8 have a configuration containing one, or two or more types of resins selected from the group consisting of an epoxy resin, an urethane resin, an acrylic ester resin, a methacrylic ester resin, and a polyethylenimine resin. By employing such a configuration, the adhesive force between the heat-resistant resin layer 2 and the outer side adhesive layer 5 can be further improved, and therefore at the time of subjecting the packaging material to deep drawing, bulging, etc., for molding, when the packaging material is heat-sealed for sealing, delamination (detachment) can be sufficiently prevented from occurring between the outer side layer (heat-resistant resin layer) 2 and the metal foil layer 4. Even when the packaging material 1 is used under a harsh environment, such as, e.g., hot and humid environment, delamination (detachment) can be sufficiently prevented from occurring between the outer side layer (heat-resistant resin layer) 2 and the metal foil layer 4.

In particular, it is especially preferable that the easily adhesive layer 8 have a configuration containing an urethane resin and an epoxy resin, or a configuration containing a (meth) acrylic ester resin and an epoxy resin. In that case, occurrence of delamination between the outer side layer (heat-resistant resin layer) 2 and the metal foil layer 4 can be more sufficiently suppressed.

In the case of employing the former configuration described above, the content mass ratio of the urethane resin/epoxy resin in the easily adhesive layer 8 is preferably in a range of 98/2 to 40/60. In this case, the adhesive force between the heat-resistant resin layer 2 and the outer side adhesive layer 5 can be further improved. It is not preferable when the content ratio of the urethane resin becomes larger than the content mass ratio of urethane resin/epoxy resin (98/2), the degree of cross-linkage becomes insufficient, resulting in insufficient solvent resistance and adhesive force, and therefore it is not preferable. On the other hand, when the content ratio of the urethane resin becomes smaller than the content mass ratio of urethane resin/epoxy resin (40/60), it takes too much time for the crosslinking to be completed, and therefore it is not preferable. In particular, it is more preferable that the content mass ratio of urethane resin/epoxy resin in the easily adhesive layer 8 is within a range of 90/10 to 50/50.

Further, in the case of employing the latter configuration described above, it is preferable that the content mass ratio of (meth) acrylic ester resin/epoxy resin in the easily adhesive layer 8 be within a range of 98/2 to 40/60. In this case, the adhesive force between the heat-resistant resin layer 2 and the outer side adhesive layer 5 can be further improved. When the content ratio of the (meth) acrylic ester resin becomes larger than the content ratio of (meth) acrylic ester resin/epoxy resin (98/2), the degree of cross-linkage becomes insufficient, which makes it difficult to obtain sufficient solvent resistance and adhesive force, and therefore it is not preferable. On the other hand, when the content ratio of the (meth) acrylic ester resin becomes smaller than the content ratio of (meth) acrylic ester resin/epoxy resin (40/60), it takes too much time for the crosslinking to be completed, and therefore it is not preferable. Among them, it is more preferable that the content mass ratio of the (meth) acrylic ester resin/epoxy resin in the easily adhesive layer 8 be within a range of 90/10 to 50/50.

Surfactants, such as, e.g., glycols, glycol ethylene oxide adducts, may be added to the resin aqueous emulsion (resin water-based emulsion) for forming the easily adhesive layer 8. In this case, sufficient anti-foaming effects can be obtained in the resin aqueous emulsion, and therefore an easily adhesive layer 8 excellent in surface smoothness can be formed. It is preferable that 0.01 mass % to 2.0 mass % of the surfactant be contained in the resin aqueous emulsion.

Further, it is preferable that an inorganic fine particle, such as, e.g., silica and colloidal silica, be included in the resin aqueous emulsion (resin water-based emulsion) for forming the easily adhesive layer 8. In this case, blocking prevention effects can be obtained. It is preferable that 0.1 parts by weight to 10 parts by weight of inorganic fine particles be added to 100 parts by weight of the resin.

It is preferable that the forming amount of the easily adhesive layer 8 (the solid compound amount after drying) be within a range of 0.01 g/m² to 0.5 g/m². When the forming amount is 0.01 g/m² or more, the heat-resistant resin layer 2 and the outer side adhesive layer 5 can be sufficiently adhered, and when it is 0.5/m² or less, the cost can be reduced and therefore it is economical.

It is preferable that the content rate of the resin in the easily adhesive layer (after drying) 8 be 88 mass % to 99.9 mass %.

In the present invention, the outer side adhesive layer (first adhesive layer) 5 is formed by an urethane adhesive curable layer containing a polyol, a polyfunctional isocyanate compound, and an aliphatic compound having a plurality of functional groups capable of reacting with an isocyanate group in one molecule.

As the polyol, although not especially limited, for example, a polyester polyol, a polyhydric alcohol, a polyether polyol, a polyester polyurethane polyol, a polyether polyurethane polyol, etc., may be exemplified. Among them, it is preferable to use a polyester polyol as the polyol from the viewpoint of capable of improving the heat-resistance.

The polyester polyol can be obtained by, for example, blending alcohol and carboxylic acid to perform a condensation polymerization reaction. That is, the polyester polyol is a condensation polymer of an alcohol component and a carboxylic acid component. For example, by blending a polyhydric alcohol and a dicarboxylic acid to perform condensation polymerization for 20 hours at 210° C., the polyester polyol can be produced.

As the polyhydric alcohol, although not especially limited, for example, a neopentyl glycol, an ethylene glycol, a 1,6-hexanediol, etc., can be exemplified. As the carboxylic acid, although not especially limited, for example, a dicarboxylic acid, such as, e.g., an aliphatic dicarboxylic acid and an aromatic dicarboxylic acid, can be exemplified. As the aliphatic dicarboxylic acid, although not especially limited, for example, an adipic acid, a succinic acid, a suberic acid, a sebacic acid, etc., can be exemplified. As the aromatic dicarboxylic acid, although not especially limited, for example, an isophthalic acid, a terephthalic acid, a naphthalene dicarboxylic acid, a phthalic anhydride, etc., can be exemplified.

It is preferable that the polyester polyol contain an aromatic dicarboxylic acid as the dicarboxylic acid component. It is preferable that the content rate of an aromatic dicarboxylic acid in the dicarboxylic acid component be 40 mol % to 80 mol %. When it is 40 mol % or more, the delamination (detachment) between the outer side layer 2 and the metal foil layer 4 can be sufficiently prevented even when drawing deep in molding depth is performed, and when it is 80 mol % or less, the sufficient adhesion of the outer adhesive (first adhesive) 5 can be obtained. In particular, it is more preferable that the content rate of an aromatic dicarboxylic acid in the dicarboxylic acid component be 50 mol % to 70 mol %.

As the number average molecular weight of the polyol, although not especially limited, it is preferably within a range of 8,000 to 30,000, more preferably within a range of 10,000 to 26,000.

As the polyfunctional isocyanate compound (curing agent), various polyfunctional isocyanate compounds of aliphatic, alicyclic, and aromatic systems can be used. As the aliphatic polyfunctional isocyanate compound, for example, a hexamethylene diisocyanate (HMDI), etc., can be exemplified. As an alicyclic polyfunctional isocyanate compound, for example, an isophorone diisocyanate (IPDI), etc., can be exemplified. As the aromatic polyfunctional isocyanate compound, for example, a tolylene diisocyanate (TDI), a diphenyl-methane diisocyanate (MDI), etc., can be exemplified. It can also be a modified product of these polyfunctional isocyanate compounds, and for example, a polyfunctional isocyanate modified product by multimerization of an isocyanurate, a carbodiimide, a polymeric, etc., can be exemplified.

As the aliphatic compound, an aliphatic compound having a plurality of functional groups that can react with an isocyanate group (NCO) in one molecule is used. The aliphatic compound includes compounds in which atoms of an oxygen, a nitrogen, a sulfur, a chlorine, etc., are combined. Further, the aliphatic compound does not include compounds having an aromatic ring. Furthermore, the aliphatic compound does not include the polyol and the polyfunctional isocyanate compound. It is preferable to use the aliphatic compound having a smaller number average molecular weight than the polyol. In particular, it is preferable that the molecular weight of the aliphatic compound be within a range of 60 to 9,500, more preferably within a range of 100 to 1,000.

As the functional group that can react with the isocyanate group (NCO), although not especially limited, for example, a hydroxyl group, an amino group, a carboxyl group, etc., can be exemplified.

As the “aliphatic compound having a plurality of functional groups that can react with an isocyanate group in one molecule”, although not especially limited, for example, a polyhydric alcohol, an aliphatic diamine, a dicarboxylic acid, etc., can be exemplified. The polyhydric alcohol is alcohol that includes two or more alcoholic hydroxyl groups in one molecule. As the polyhydric alcohol, although not especially limited, for example, a trimethylolpropane (TMP), a methyl pentanediol, a dimethyl butanediol, an ethylene glycol, glycerin, a carbitol, sorbitol, etc., can be exemplified.

In the outer side adhesive layer 5, the ratio of the number of moles in the isocyanate group (NCO) of the polyfunctional isocyanate compound to the number of moles of the hydroxyl group (OH) of the polyol (equivalent ratio [NCO]/[OH]) is preferably set within a range of 2 to 25. In particular, it is especially preferable that the equivalent ratio [NCO]/[OH] is set within a range to 5 to 20.

It is preferable that the thickness (thickness after drying) of the outer side adhesive layer (first adhesive layer) 5 be set 1 μm to 6 μm.

A configuration in which Young's modulus of the curable layer of the urethane adhesive agent constituting the outer side adhesive layer 5 is in a range of 90 MPa to 400 MPa is preferable. When the Young's modulus is 90 MPa or more, the heat-resistance of the outer side adhesive layer 5 can be improved, and even when performing deep depth molding (molding in which molding depth is deep), delamination (detachment) can be sufficiently prevented from occurring between the outer side layer 2 and the metal foil layer 4. When the Young's modulus is 400 MPa or less, the adhesion of the urethane adhesive curable film can be improved and the lamination strength under a hot and humid environment can be sufficiently improved. In particular, it is especially preferable that the Young's modulus of the urethane adhesive curable film constituting the outer side adhesive layer 5 be within a range of 140 MPa to 300 MPa. Further, the Young's modulus is a Young's modulus measured in accordance with JIS K7127-1999.

In the present invention, the metal foil layer 4 plays a role of providing a gas barrier property to prevent the intrusion of oxygen and/or moisture to the packaging material 1. As the metal foil layer 4, although not especially limited, for example, an aluminum foil, a copper foil, etc., can be exemplified, and an aluminum foil is generally used. It is preferable that the thickness of the metal foil layer 4 be 20 μm to 100 μm. When the thickness is 20 μm or more, formation of pinholes can be prevented at the time of rolling to produce the metal foil. When the thickness is 100 μm or less, the stress at the time of bulging and drawing molding can be reduced to thereby improve the formability.

In the metal foil layer 4, it is preferable that at least the inner surface (the inner adhesive layer 6 side surface) of the metal foil layer be subjected to a chemical conversion treatment. When subjected to such a chemical conversion treatment, corrosion of the surface of the metal foil by the contents (battery electrolyte, etc.) can be sufficiently prevented. A chemical conversion treatment of a metal foil can be performed by, for example, the following processes. That is, for example, a chemical conversion treatment is performed by applying any one of the following water solutions 1) to 3) to a surface of a degreased metal foil, and then drying it:

1) a water solution of a mixture containing:
a phosphoric acid;
a chromium acid; and
at least one type of compound selected from the group consisting of a fluoride metal salt and a fluoride non-metal salt

2) a water solution of a mixture containing:
a phosphoric acid;
at least one type of resin selected from the group consisting of an acryl-based resin, a chitosan derivative resin, and a phenol-based resin; and at least one type of compound selected form the group consisting of chromic acid and chromium (III) salt;

3) a water solution made of a mixture of:
a phosphoric acid;
at least one type of resin selected from the group consisting of an acrylic resin, a chitosan derivative resin, and a phenolic resin;
at least one type of compound selected from the group consisting of a chromic acid and a chromium (III) salt; and
at least one type of compound selected from the group consisting of a fluoride metal salt and a fluoride non-metal salt.

In the chemical conversion film, it is preferable that the adhesion amount of chromium (per one side) be 0.1 mg/m² to 50 mg/m², especially preferably 2 mg/m² to 20 mg/m².

The heat-fusible resin layer (inner side layer) 3 plays a role of giving excellent chemical resistance against highly corrosive electrolyte used for, e.g., a lithium ion secondary battery and a heat-sealing performance to the packaging material.

As the resin constituting the heat-fusible resin layer 3, although not especially limited, for example, a polyethylene, a polypropylene, an ionomer, an ethylene ethyl acrylate (EEA), an ethylene methyl acrylate (EAA), ethylene/methyl methacrylate (EMMA) resin, an ethylene-vinyl acetate copolymer resin (EVA), a maleic anhydride modified polypropylene, a maleic anhydride modified polyethylene, etc., can be exemplified.

It is preferable that the thickness of the heat-fusible resin layer 3 be set to 15 μm to 30 μm. By setting it to 15 μm or more, sufficient heat-sealing strength can be obtained. By setting it to 30 μm or less, it contributes to thinning and weight reduction of the film. It is preferable that the heat-fusible resin layer 13 be formed by a heat-fusible resin unstretched film layer. The heat-fusible resin layer 13 can be a single layer or a multi-layer.

As the inner adhesive layer (second adhesive layer) 6, although not especially limited, for example, it is preferable to use a curing type adhesive agent. As the curing type adhesive agent, for example, a thermosetting type acrylic adhesive agent, a thermosetting type acid-modified polypropylene adhesive agent, a thermosetting type polyurethane-based adhesive agent, etc., can be exemplified. In particular, it is preferable to use the thermosetting type acrylic adhesive agent. In this case, there is an advantage that the heat aging process temperature for accelerating curing can be lowered (for example,)40° C., and by lowering it as such, an advantageous effect can be obtained in which occurrence of white powder in the heat-fusible resin layer 3 due to the heat aging processing can be sufficiently prevented. It is preferable that the thickness (thickness after drying) of the inner adhesive layer 6 be set between 1 μm to 4 μm.

By shaping (deep drawing, bulging, etc.) the packaging material 1 of the present invention, a case (battery case, etc.) 10 can be obtained (see FIG. 4). The packaging material 1 of the present invention can be used as it is without being shaped (see FIG. 4).

An embodiment of the power storage device 30 constituted using the packaging material 1 of the present invention is shown in FIG. 3. The power storage device 30 is a lithium-ion secondary battery. In this embodiment, as shown in FIGS. 3 and 4, an exterior material 15 is constituted by a case 10 obtained by molding the packaging material 1 and a planar packaging material 1 which was not molded. Thus, the power storage device 30 of the present invention is constituted as follows. An approximately rectangular shaped power storage device main body (electrochemical element, etc.) 31 is accommodated inside an accommodation concave part of a molded case 10 obtained by molding the packaging material 1 of the present invention. The packaging material 1 of the present invention which is not molded is arranged on the power storage device main body 31 with the inner side layer 3 side of the packaging material faced inwardly (downwardly). The peripheral edge part of the inner side layer 3 of the planar packaging material 1 and the inner side layer 3 of the flange part (sealing peripheral edge part) 29 of the molded case 10 are sealingly joined by heat-sealing (see FIGS. 3 and 4). The inner side surface of the accommodating concave part of the case 10 is the inner side layer (heat-fusible resin layer) 3, and the outer surface of the accommodating concave part is the outer side layer (heat-resistant resin layer) 2 (see FIG. 4).

In FIG. 3, the reference numeral “39” denotes a heat-sealed part in which the peripheral edge part of the packaging material 1 and the flange part (sealing peripheral edge part) 29 of the case 10 are joined (welded). In the power storage device 30, a front edge part of a tab lead connected to the power storage device main body 31 is led to the outside of the exterior material 15, but it is not illustrated in the drawing.

As the power storage device main body 31, although not especially limited, for example, a battery main body, a capacitor main body, a condenser main body, etc., can be exemplified.

It is preferable that the width of the heat-sealed part 39 be set to 0.5 mm or more. By setting it to 0.5 mm or more, sealing can be assuredly performed. In particular, it is preferable that the width of the heat-sealed part 39 be set to 3 mm to 15 mm.

In the aforementioned embodiment, the exterior material 15 is constituted by a molded case 10 obtained by molding the packaging material 1 and a planar exterior material 1 (see FIGS. 3 and 4), but it is not particularly limited to such a combination. For example, the exterior material 15 can be constituted by a pair of packaging materials 1 or a pair of molded cases 10.

Next, a method of producing the packaging material according to the present invention will be explained.

Initially, a laminated product is prepared (Preparation step). The laminated product includes a heat-resistant resin layer (outer side layer) 2 made of a heat-resistant resin film having a hot water shrinkage rate of 1.5% to 12%, a heat-fusible resin layer (inner side layer) 3, and a metal foil layer 4 arranged between the heat-resistant resin layer and the heat-fusible resin layer (preparation step). The heat-fusible resin layer 3 and the metal foil layer 4 are adhered via a curing type inner side adhesive agent. The heat-resistant resin layer 2 and the metal foil layer 4 are adhered via a heat curing type outer side adhesive agent containing a polyol, a polyfunctional isocyanate compound, and an aliphatic compound having a plurality of functional groups that may react with an isocyanate group in one molecule.

As to what kind of material can be used as the polyol, as the polyfunctional isocyanate compound, and as the “aliphatic compound having a plurality of functional groups that may react with an isocyanate group in one molecule” is as described above.

As the curing type inner side adhesive agent, although not particularly limited, for example, a thermosetting type acrylic adhesive agent, a thermosetting type acid-modified polypropylene adhesive agent, a thermosetting type polyurethane-based adhesive agent, etc., can be exemplified. In particular, it is preferable to use a thermosetting type acrylic adhesive agent.

Next, the curing type inner side adhesive agent and the curing type outer side adhesive agent in the laminated product are cured. Preferably, the curing type inner side adhesive agent and the curing type outer side adhesive agent are cured by subjecting the laminated product to a heat treatment in a temperature range of 37° C. to 55° C. (Aging processing step). The packaging material 2 of the present invention can be obtained via the aging processing step. It is especially preferable to perform the heat treatment at 38° C. to 52° C.

The duration for the heat treatment (heat aging processing) is not especially limited. For example, in the case of using a thermosetting type acrylic adhesive agent as a curing type inner side adhesive agent, it is preferable to perform the heat treatment for 3 days to 15 days. In the case of using a thermosetting type acid-modified polypropylene adhesive agent as a curing type inner side adhesive agent, it is preferable to perform the heat treatment for 3 days to 15 days. In the case of using a thermosetting type polyurethane-based adhesive agent as a curing type inner side adhesive agent, it is preferable to perform the heat treatment for 3 days to 15 days.

### EXAMPLE

Next, specific Examples of the present invention will be explained. It should be noted, however, that the present invention is not especially limited to these Examples.

### Example 1

A chemical conversion film was formed on both surfaces of an aluminum foil (A8079 aluminum foil defined by JIS H4160) having a thickness of 35 μm by applying a chemical conversion treatment solution containing phosphoric acid, a polyacrylic acid (acryl-based resin), a chromium (III) salt compound, water, and an alcohol and then drying at 180ºC. The chromium adhesion amount of the chemical conversion film was 10 mg/m² per one surface.

Next, a heat curing type outer side adhesive agent containing 100 parts by weight of a polyester polyol having a number average molecular weight of 25,000, 25 parts by weight of tolylene diisocyanate (TDI), and 10 parts by weight of a trimethylolpropane (TMP) was applied to one of surfaces of the aluminum foil 4 subjected to the chemical conversion treatment so that the mass after drying became 3.5 g/m².

The polyester polyol was a polyester polyol obtained by mixing a dicarboxylic acid component composed of 50 mole parts of an adipic acid (aliphatic dicarboxylic acid) and 50 mole parts of an isophthalic acid (aromatic dicarboxylic acid), and a polyhydric alcohol component composed of 30 mole parts of a neopentyl glycol, 30 mole parts of an ethylene glycol, and 40 mole parts of a 1,6-hexanediol to carry out condensation polymerization for 20 hours at 210° C. Therefore, the content rate of the aromatic dicarboxylic acid in the dicarboxylic acid component was 50 mol %.

Further, in the aforementioned heat curing type outer side adhesive agent, the ratio of the number of moles in the isocyanate group (NCO) of the tolylene diisocyanate (TDI) to the number of moles of the hydroxyl group (OH) of the polyester polyol (equivalent ratio [NCO]/[OH]) was 10.

On the other hand, an easily adhesive layer 8 having a thickness of 0.05 μm was formed by applying a resin in which 70 parts by weight of urethane resin and 30 parts by weight of epoxy resin 30 were mixed to one surface of the biaxially stretched polyamide film 2 having a hot water shrinkage rate of 2.0% and a thickness of 15 μm by a spray coating method and drying it. Thus, a biaxially stretched polyamide film 2 having an easily adhesive layer 8 was obtained. The biaxially stretched polyamide film 2 having a hot water shrinkage rate of 2.0% was obtained by setting the heat setting temperature at 214ºC at the time of biaxially stretching the polyamide film.

The easily adhesive layer side surface of the polyamide film 2 having the easily adhesive layer 8 was laminated and adhered on the outer side adhesive agent applied surface of the one of surfaces of the aluminum foil 4.

Next, a laminated product was obtained by applying an inner side adhesive agent composed of a thermosetting type acid-modified polypropylene adhesive agent on the other surface of the aluminum foil 4 so that the mass after drying became 2.5 g/m², and then adhering an unstretched polypropylene film 3 having a thickness of 30 μm on the inner side adhesive agent applied surface.

A packaging material 1 having a configuration shown in FIG. 2 was obtained by subjecting the laminated product to heat aging processing by leaving it for 9 days in a 40° C. environment to simultaneously cure the heat curing type outer side adhesive agent and the heat curing type inner side adhesive agent to thereby form the outer side adhesive layer 5 and the inner adhesive layer 6.

### Example 2

A packaging material 1 having a configuration shown in FIG. 2 was obtained in the same manner as in Example 1 except that a dicarboxylic acid component comprised of 40 mole parts of an adipic acid (aliphatic dicarboxylic acid) and 60 mole parts of an isophthalic acid (aromatic dicarboxylic acid) was used as the dicarboxylic acid component.

### Example 3

A packaging material 1 having a configuration shown in FIG. 2 was obtained in the same manner as in Example 1 except that a dicarboxylic acid component composed of 30 mole parts of an adipic acid (aliphatic dicarboxylic acid) and 70 mole parts of an isophthalic acid (aromatic dicarboxylic acid) was used as the dicarboxylic acid component.

### Example 4

A packaging material 1 having a configuration shown in FIG. 2 was obtained in the same manner as in Example 3 except that a biaxially stretched polyamide film having a hot water shrinkage rate of 5.0% was used as the biaxially stretched polyamide film 2. The biaxially stretched polyamide film 2 having a hot water shrinkage rate of 5.0% was obtained by setting the heat setting temperature at 191ºC at the time of biaxially stretching the polyamide film.

### Example 5

A packaging material 1 having a configuration as shown in FIG. 2 was obtained in the same manner as in Example 3 except that a biaxially stretched polyamide film having a hot water shrinkage rate of 10.0% was used as the biaxially stretched polyamide film 2. The biaxially stretched polyamide film 2 having a hot water shrinkage rate of 10.0% was obtained by setting the heat setting temperature at 160° C. at the time of biaxially stretching the polyamide film.

### Example 6

A packaging material 1 having a configuration shown in FIG. 2 was obtained in the same manner as in Example 3 except that for the heat curing type outer side adhesive agent, the ratio of the number of moles of the isocyanate group (NCO) of the tolylene diisocyanate (TDI) to the number of moles of the hydroxyl group (OH) of the polyester polyol (equivalent ratio [NCO]/[OH]) was set to 25.

### Example 7

A packaging material 1 having a configuration shown in FIG. 2 was obtained in the same manner as in Example 3 except that 100 parts by weight of polyether polyol having a number average molecular weight of 28,000 was used in place of 100 parts by weight of a polyester polyol having a number average molecular weight of 25,000.

### Example 8

A packaging material 1 having a configuration shown in FIG. 2 was obtained in the same manner as in Example 3 except that 25 parts by weight of a diphenyl-methane diisocyanate (MDI) was used in place of 25 parts by weight of a tolylene diisocyanate (TDI).

### Example 9

A packaging material 1 having a configuration shown in FIG. 2 was obtained in the same manner as in Example 3 except that 6 parts by weight of an ethylene glycol (EG) was used in place of 10 parts by weight of a trimethylolpropane (TMP).

### Example 10

A packaging material 1 having a configuration shown in FIG. 2 was obtained in the same manner as in Example 3 except that 9 parts by weight of glycerin was used in place of 10 parts by weight of a trimethylolpropane (TMP).

### Example 11

A packaging material 1 having a configuration shown in FIG. 1 was obtained in the same manner as in Example 3 except that the easily adhesive layer 8 was not provided. That is, in Example 3, the surface of the easily adhesive layer side of the polyamide film having the easily adhesive layer was laminated and adhered on the outer side adhesive agent applied surface of one of the surfaces of the aluminum foil 4. However, in place of that, a biaxially stretched polyamide film having a hot water shrinkage rate of 2.0% and a thickness of 15 μm was laminated and adhered on the outer side adhesive agent applied surface of the other surface of the aluminum foil 4.

### Example 12

A packaging material 1 having a configuration shown in FIG. 1 was obtained in the same manner as in Example 11 except that a dicarboxylic acid component composed of 70 mole parts of an adipic acid (aliphatic dicarboxylic acid) and 30 mole parts of isophthalic acid (aromatic dicarboxylic acid) was used.

### Example 13

A packaging material 1 having a configuration shown in FIG. 2 was obtained in the same manner as in Example 1 except that a dicarboxylic acid component comprised of 70 mole parts of an adipic acid (aliphatic dicarboxylic acid) and 30 mole parts of an isophthalic acid (aromatic dicarboxylic acid) was used.

### Example 14

A packaging material 1 having a configuration shown in FIG. 1 was obtained in the same manner as in Example 6 except that a dicarboxylic acid component comprised of 10 mole parts of an adipic acid (aliphatic dicarboxylic acid) and 90 mole parts of an isophthalic acid (aromatic dicarboxylic acid) was used as the dicarboxylic acid component and the easily adhesive layer 8 was not provided.

### Example 15

A packaging material 1 having a configuration shown in FIG. 2 was obtained in the same manner as in Example 6 except that a dicarboxylic acid component comprised of 10 mole parts of an adipic acid (aliphatic dicarboxylic acid) and 90 mole parts of isophthalic acid (aromatic dicarboxylic acid) was used.

### Example 16

A packaging material 1 having a configuration shown in FIG. 1 was obtained in the same manner as in Example 1 except that the easily adhesive layer 8 was not provided. That is, in Example 1, the surface of the easily adhesive layer side of the polyamide film having the easily adhesive layer was laminated and the outer side adhesive agent applied surface on one of the surfaces of the aluminum foil 4. However, in place of that, a biaxially stretched polyamide film having a hot water shrinkage rate of 2.0% and a thickness of 15 μm was laminated and adhered on the outer side adhesive agent applied surface of the other surface of the aluminum foil 4.

### Example 17

A packaging material 1 having a configuration shown in FIG. 1 was obtained in the same manner as in Example 2 except that the easily adhesive layer 8 was not provided. That is, in Example 2, the surface of the easily adhesive layer side of the polyamide film having the easily adhesive layer was laminated and adhered on the outer side adhesive agent applied surface of one of the surfaces of the aluminum foil 4. However, in place of that, a biaxially stretched polyamide film having a hot water shrinkage rate of 2.0% and a thickness of 15 μm was laminated and adhered on the outer side adhesive agent applied surface of the other surface of the aluminum foil 4.

### Example 18

A packaging material 1 having a configuration shown in FIG. 1 was obtained in the same manner as in Example 3 except that the easily adhesive layer 8 was not provided. That is, in Example 3, the surface of the easily adhesive layer side of the polyamide film having the easily adhesive layer was laminated and adhered on the outer side adhesive agent applied surface of one of the surfaces of the aluminum foil 4. However, in place of that, a biaxially stretched polyamide film having a hot water shrinkage rate of 2.0% and a thickness of 15 μm was laminated and adhered on the outer side adhesive agent applied surface of the other surface of the aluminum foil 4.

### Example 19

A packaging material 1 having a configuration shown in FIG. 1 was obtained in the same manner as in Example 6 except that the easily adhesive layer 8 was not provided. That is, in Example 6, the surface of the easily adhesive layer side of the polyamide film having the easily adhesive layer was laminated and adhered on the outer side adhesive agent applied surface of one of the surfaces of the aluminum foil 4. However, in place of that, a biaxially stretched polyamide film having a hot water shrinkage rate of 2.0% and a thickness of 15 μm was laminated and adhered on the outer side adhesive agent applied surface on the other surface of the aluminum foil 4.

### Comparative Example 1

A packaging material was obtained in the same manner as in Example 12 except that a biaxially stretched polyamide film having a hot water shrinkage rate of 1.0% was used as the biaxially stretched polyamide film 2. The biaxially stretched polyamide film 2 having a hot water shrinkage rate of 1.0% was obtained by setting the heat setting temperature at 221° C. at the time of biaxially stretching the polyamide film.

### Comparative Example 2

A packaging material was obtained in the same manner as in Example 14 except that a biaxially stretched polyamide film having a hot water shrinkage rate of 1.0% was used as the biaxially stretched polyamide film 2. The biaxially stretched polyamide film 2 having a hot water shrinkage rate of 1.0% was obtained by setting the heat setting temperature at 221° C. at the time of biaxially stretching the polyamide film.

### Comparative Example 3

A packaging material 1 having a configuration shown in FIG. 2 was obtained in the same manner as in Example 1 except that a biaxially stretched polyamide film having a hot water shrinkage rate of 1.0% was used as the biaxially stretched polyamide film 2. The biaxially stretched polyamide film 2 having a hot water shrinkage rate of 1.0% was obtained by setting the heat setting temperature at 221° C. at the time of biaxially stretching the polyamide film.

### Comparative Example 4

A packaging material was obtained in the same manner as in Example 2 except that a biaxially stretched polyamide film having a hot water shrinkage rate of 1.0% was used as the biaxially stretched polyamide film 2. The biaxially stretched polyamide film 2 having a hot water shrinkage rate of 1.0% was obtained by setting the heat setting temperature at 221° C. at the time of biaxially stretching the polyamide film.

### Comparative Example 5

A packaging material was obtained in the same manner as in Example 3 except that a biaxially stretched polyamide film having a hot water shrinkage rate of 1.0% was used as the biaxially stretched polyamide film 2. The biaxially stretched polyamide film 2 having a hot water shrinkage rate of 1.0% was obtained by setting the heat setting temperature at 221° C. at the time of biaxially stretching the polyamide film.

### Comparative Example 6

A packaging material was obtained in the same manner as in Example 6 except that a biaxially stretched polyamide film having a hot water shrinkage rate of 1.0% was used as the biaxially stretched polyamide film 2. The biaxially stretched polyamide film 2 having a hot water shrinkage rate of 1.0% was obtained by setting the heat setting temperature at 221° C. at the time of biaxially stretching the polyamide film.

### Comparative Example 7

A packaging material was obtained in the same manner as in Example 3 except that a biaxially stretched polyamide film having a hot water shrinkage rate of 15.0% was used as the biaxially stretched polyamide film 2. The biaxially stretched polyamide film 2 having a hot water shrinkage rate of 15.0% was obtained by setting the heat setting temperature at 135° C. at the time of biaxially stretching the polyamide film.

### Comparative Example 8

A packaging material was obtained in the same manner as in Example 3 except that a heat curing type outer side adhesive agent (not containing an aliphatic compound such as TMP, etc.) containing 100 parts by weight of a polyester polyol having a number average molecular weight of 25,000 and 25 parts by weight of tolylene diisocyanate (TDI) was used as the heat curing type outer side adhesive agent.

TABLE 1

| | Outer | Existence | Outer side adhesive layer | | | | |
|---|---|---|---|---|---|---|---|
| | layer | or non- | | | | | Content rate |
| | Hot water | existence | | | | | of aromatic |
| | shrinkage | of easily | | Polyfunctional | | Equivalent | dicarboxylic |
| | rate | adhesive | | isocyanate | Aliphatic | ratio | acid |
| | (%) | layer | Polyol | compound | compound | [NCO]/[OH] | (mole %) |
| Ex. 1 | 2.0 | Yes | Polyester | TDI | TMP | 10 | 50 |
| | | | polyol | | | | |
| Ex. 2 | 2.0 | Yes | Polyester | TDI | TMP | 10 | 60 |
| | | | polyol | | | | |
| Ex. 3 | 2.0 | Yes | Polyester | TDI | TMP | 10 | 70 |
| | | | polyol | | | | |
| Ex. 4 | 5.0 | Yes | Polyester | TDI | TMP | 10 | 70 |
| | | | polyol | | | | |
| Ex. 5 | 10.0 | Yes | Polyester | TDI | TMP | 10 | 70 |
| | | | polyol | | | | |
| Ex. 6 | 2.0 | Yes | Polyester | TDI | TMP | 25 | 70 |
| | | | polyol | | | | |
| Ex. 7 | 2.0 | Yes | Polyester | TDI | TMP | 10 | 70 |
| | | | polyol | | | | |
| Ex. 8 | 2.0 | Yes | Polyester | MDI | TMP | 10 | 70 |
| | | | polyol | | | | |
| Ex. 9 | 2.0 | Yes | Polyester | TDI | EG | 10 | 70 |
| | | | polyol | | | | |
| Ex. 10 | 2.0 | Yes | Polyester | TDI | Glycerin | 10 | 70 |
| | | | polyol | | | | |
| Ex. 11 | 2.0 | No | Polyester | TDI | TMP | 10 | 70 |
| | | | polyol | | | | |

| | Evaluation results | | | | |
|---|---|---|---|---|---|
| | | | Sealing | Heat water | |
| | | | performance | resistance | |
| | Young's | | (presence or | (presence or | |
| | modulus | | absence of | absence of | Lamination |
| | (MPa) | Formability | detachment) | detachment) | strength |
| Ex. 1 | 90 | ◯ | ◯ | ◯ | ◯ |
| Ex. 2 | 140 | ◯ | ◯ | ◯ | ◯ |
| Ex. 3 | 300 | ◯ | ◯ | ◯ | ◯ |
| Ex. 4 | 300 | ◯ | ◯ | ◯ | ◯ |
| Ex. 5 | 300 | ◯ | ◯ | ◯ | ◯ |
| Ex. 6 | 400 | ◯ | ◯ | ◯ | ◯ |
| Ex. 7 | 280 | ◯ | ◯ | ◯ | ◯ |
| Ex. 8 | 250 | ◯ | ◯ | ◯ | ◯ |
| Ex. 9 | 320 | ◯ | ◯ | ◯ | ◯ |
| Ex. 10 | 270 | ◯ | ◯ | ◯ | ◯ |
| Ex. 11 | 300 | ◯ | ◯ | Δ | ◯ |

EG: ethylene glycol
Equivalent ratio [NCO]/[OH] = [the number of moles of NCO groups of polyfunctional isocyanate compound]/[the number of moles of hydroxyl group of polyol]

TABLE 2

| | Outer | Existence | Outer side adhesive layer | | | | |
|---|---|---|---|---|---|---|---|
| | layer | or non- | | | | | Content rate |
| | Hot water | existence | | | | | of aromatic |
| | shrinkage | of easily | | Polyfunctional | | Equivalent | dicarboxylic |
| | rate | adhesive | | isocyanate | Aliphatic | ratio | acid |
| | (%) | layer | Polyol | compound | compound | [NCO]/[OH] | (mole %) |
| Ex. 12 | 2.0 | No | Polyester | TDI | TMP | 10 | 30 |
| | | | polyol | | | | |
| Ex. 13 | 2.0 | Yes | Polyester | TDI | TMP | 10 | 30 |
| | | | polyol | | | | |
| Ex. 14 | 2.0 | No | Polyester | TDI | TMP | 25 | 90 |
| | | | polyol | | | | |
| Ex. 15 | 2.0 | Yes | Polyester | TDI | TMP | 25 | 90 |
| | | | polyol | | | | |
| Ex. 16 | 2.0 | No | Polyester | TDI | TMP | 10 | 50 |
| | | | polyol | | | | |
| Ex. 17 | 2.0 | No | Polyester | TDI | TMP | 10 | 60 |
| | | | polyol | | | | |
| Ex. 18 | 2.0 | No | Polyester | TDI | TMP | 10 | 70 |
| | | | polyol | | | | |
| Ex. 19 | 2.0 | No | Polyester | TDI | TMP | 25 | 70 |
| | | | polyol | | | | |

| | Evaluation results | | | | |
|---|---|---|---|---|---|
| | | | Sealing | Heat water | |
| | | | performance | resistance | |
| | Young's | | (presence or | (presence or | |
| | modulus | | absence of | absence of | Lamination |
| | (MPa) | Formability | detachment) | detachment) | strength |
| Ex. 12 | 50 | Δ | Δ | Δ | Δ |
| Ex. 13 | 50 | ◯ | Δ | Δ | ◯ |
| Ex. 14 | 520 | ◯ | ◯ | Δ | Δ |
| Ex. 15 | 520 | ◯ | ◯ | ◯ | Δ |
| Ex. 16 | 90 | ◯ | ◯ | Δ | Δ |
| Ex. 17 | 140 | ◯ | ◯ | Δ | Δ |
| Ex. 18 | 300 | ◯ | ◯ | Δ | Δ |
| Ex. 19 | 400 | ◯ | ◯ | Δ | Δ |

Equivalent ratio [NCO]/[OH] = [the number of moles of NCO group of polyfunctional isocyanate compound]/[the number of moles of hydroxyl group of polyol]

TABLE 3

| | Outer | Existence | Outer side adhesive layer | | | | |
|---|---|---|---|---|---|---|---|
| | layer | or non- | | | | | Content rate |
| | Hot water | existence | | | | | of aromatic |
| | shrinkage | of easily | | Polyfunctional | | Equivalent | dicarboxylic |
| | rate | adhesive | | isocyanate | Aliphatic | ratio | acid |
| | (%) | layer | Polyol | compound | compound | [NCO]/[OH] | (mole %) |
| Com. | 1.0 | No | Polyester | TDI | TMP | 10 | 30 |
| Ex. 1 | | | polyol | | | | |
| Com. | 1.0 | No | Polyester | TDI | TMP | 25 | 90 |
| Ex. 2 | | | polyol | | | | |
| Com. | 1.0 | Yes | Polyester | TDI | TMP | 10 | 50 |
| Ex. 3 | | | polyol | | | | |
| Com. | 1.0 | Yes | Polyester | TDI | TMP | 10 | 60 |
| Ex. 4 | | | polyol | | | | |
| Com. | 1.0 | Yes | Polyester | TDI | TMP | 10 | 70 |
| Ex. 5 | | | polyol | | | | |
| Com. | 1.0 | Yes | Polyester | TDI | TMP | 25 | 70 |
| Ex. 6 | | | polyol | | | | |
| Com. | 15.0 | Yes | Polyester | TDI | TMP | 10 | 70 |
| Ex. 7 | | | polyol | | | | |
| Com. | 2.0 | Yes | Polyester | TDI | — | 10 | 70 |
| Ex. 8 | | | polyol | | | | |

| | Evaluation results | | | | |
|---|---|---|---|---|---|
| | | | Sealing | Heat water | |
| | | | performance | resistance | |
| | Young's | | (presence or | (presence or | |
| | modulus | | absence of | absence of | Lamination |
| | (MPa) | Formability | detachment) | detachment) | strength |
| Com. | 50 | X | X | Δ | X |
| Ex. 1 | | | | | |
| Com. | 520 | X | ◯ | ◯ | X |
| Ex. 2 | | | | | |
| Com. | 90 | X | ◯ | ◯ | X |
| Ex. 3 | | | | | |
| Com. | 140 | X | ◯ | ◯ | X |
| Ex. 4 | | | | | |
| Com. | 300 | X | ◯ | ◯ | X |
| Ex. 5 | | | | | |
| Com. | 400 | X | ◯ | ◯ | X |
| Ex. 6 | | | | | |
| Com. | 300 | ◯ | X | ◯ | ◯ |
| Ex. 7 | | | | | |
| Com. | 350 | ◯ | X | Δ | X |
| Ex. 8 | | | | | |

Equivalent ratio [NCO]/[OH] = [the number of moles of NCO group of polyfunctional isocyanate compound]/[the number of moles of hydroxyl group of polyol]

For each of the molding packaging materials obtained as described above, evaluations were performed based on the following measurement method and evaluation method.

### <Young's Modulus Measurement Method>

Young's modulus (MPa) of the cured film in which each of the outer side adhesive agents used in Examples and Comparative Examples were measured in accordance with JIS K7127-1999. Specifically, after each outer side adhesive agent was applied on a glass plate so that the thickness became 50 μm, heat aging processing was performed for 11 days at 40° C. to thermally cure the outer side adhesive agent to obtain a cured material having a thickness of 46 μm. After detaching the cured material from the glass plate, a test piece was produced by cutting the cured material into a piece having a width of 15 mm and a length of 100 mm, and the Young's modulus (MPa) was measured by performing a tensile test of the test piece using a Strograph manufactured by Shimadzu Corporation (AGS-5kNX) at a tension speed of 200 mm/min.

### <Formability Evaluation Method>

Using a deep drawing device manufactured by Amada Corp., a packaging material was subjected to deep drawing into an approximately rectangular shape having a length of 55 mm, a width of 35 mm, and each of the depths (approximately rectangular shape in which one surface is open), that is, deep drawing was performed by changing the molding depth, and the presence or absence of pinholes and cracks at corner parts of the obtained molded product was examined. Then, the “maximum molding depth (mm)” in which such pinholes and breakage did not occur was researched and evaluated based on the following evaluation criteria. The presence or absence of pinholes and cracks was examined by a light transmission method in a darkroom.

### (Evaluation Criteria)

“◯” . . . the maximum molding depth with no occurrence of pinholes and cracks was 5 mm or more

“Δ” . . . the maximum molding depth with no occurrence of pinholes or cracks was 4 mm or more and 5 mm or less

“X” . . . the maximum molding depth with no occurrence of pinholes and cracks was less than 4 mm

### <Sealing Evaluation Method>

(Evaluation for the Presence or Absence of Occurrence of Delamination when Performing Deep Depth Molding (Molding in which its Molding Depth is Deep))

As molding deep in depth, a packaging material was subjected to deep drawing into an approximately rectangular shape (an approximately rectangular shape in which one surface is open) having a length of 55 mm, a width of 35 mm, and a height of 5 mm using the aforementioned deep drawing device. At this time, the molding was performed so that the heat-resistant resin layer 2 was arranged on the outside of the molded product. Two molded products were produced for each of Examples and Comparative Examples, and the flange parts (sealing peripheral edge part; see FIG. 4) 29 of the two molded products 10 were brought into contact and laminated to perform heat-sealing for 6 seconds at 170° C. After that, the presence or absence of occurrence of delaminated (detachment) in the heat-sealed part 39 was examined visually and evaluated based on the following evaluation criteria.

### (Evaluation Criteria)

“◯” . . . there was no delamination (detachment) and there was no lifting in the outer appearance (pass)

“Δ” . . . slight delamination (detachment) rarely occurred, but there was essentially no delamination (detachment) and no lifting in the outer appearance (pass)

“X” . . . there was occurrence of delamination (detachment) and there was lifting in the outer appearance (fail)

### <Hot Water Resistance Evaluation Method>

(Evaluation of Presence or Absence of Occurrence of Delamination when Used Under a Harsh Environment, Such as, e.g., Hot and Humid Environment)

As packaging material was subjected to deep drawing into an approximately rectangular shape (an approximately rectangular shape in which one surface was open) having a length of 55 mm, a width of 35 mm, and a depth of 5 mm using the aforementioned deep drawing device. At this time, the molding was performed so that the heat-resistant resin layer 2 was arranged on the outside of the molded body. Two molded products were produced for each of Examples and Comparative Examples, and the flange parts (sealing peripheral edge part; see FIG. 4) 29 of the two molded products 10 were brought into contact and laminated to perform heat-sealing for 6 seconds at 170° C. Next, the heat-sealed material was immersed in hot water at 85ºC for 240 hours and removed. After that, the presence or absence of occurrence of delaminated (detachment) in the heat-sealed part 39 was examined visually and evaluated based on the following evaluation criteria.

### (Evaluation Criteria)

“◯” . . . there was no delamination (detachment) and there was no lifting in the outer appearance (pass)

“Δ” . . . slight delamination (detachment) rarely occurred, but there was essentially no delamination (detachment) and no lifting in the outer appearance (pass)

“X” . . . there were occurrence of delamination (detachment) and there was lifting in the outer appearance (fail)

### <High Temperature Lamination Strength Measurement Method>

A test piece having a width of 15 mm and a length of 150 mm was cut out from the obtained packaging material, and in a region from one end in the lengthwise direction of the test piece to a position 10 mm inward, the aluminum foil and the heat-resistant resin layer were detached therebetween.

In accordance with JIS K6854-3 (1999) and using Strograph manufactured by Shimadzu Corporation (AGS-5kNX), a laminated body including an aluminum foil was clamped and fixed with one of the chucks, and the peeled heat-resistant resin layer was clamped and fixed with the other chuck and it was left for 1 minute under 120° C. temperature environment. Then, the peeling strength when T-type peeled at a tension speed of 100 mm/min was measured under 120° C. temperature environment, and the value when the measured value became stable was referred to as “high temperature lamination strength (N/15 mm width). The measure results were evaluated based on the following evaluation criteria.

### (Evaluation Criteria)

“◯” . . . lamination strength was “2.0 N/15 mm width” or more

“Δ” . . . lamination strength was “1.5 N/15 mm width” or more and less than “2.0 N/15 mm width”

“X” . . . lamination strength was less than “1.5 N/15 mm width”

As will be apparent from the Tables, the packaging materials according to Examples 1 to 19 of the present invention was excellent in formability in which pinholes and/or cracks did not occur even when deep depth molding (molding in which its molding depth is deep) was performed, making it capable of preventing delamination (detachment) even when deep depth molding (molding in which its molding depth is deep) was performed and also had a large lamination strength even at high temperature and had an excellent hot water resistance, making it capable of suppressing delamination (detachment) even when used under a harsh environment, such as, e.g., hot and humid environment.

On the other hand, in Comparative Examples 1 to 8 which deviated from the defined range of claims of the present invention, at least some of the evaluation were evaluated as “X” (poor).

### INDUSTRIAL APPLICABILITY

The packaging material according to the present invention can be preferably used as a packaging material for a lithium-ion polymer secondary battery for laptop computers, mobile phones, vehicles, and stationary devices. It can be suitably used as a packaging material for foods and a packaging material for pharmaceutical products, but its use is not specifically limited to them. In particular, it is especially suitable as a packaging material for batteries. Further, the packaging material of the present invention is suitable as a molding packaging material.

The case (molded case) of the present invention is suitably used as a battery case for a lithium-ion polymer secondary battery for laptop computers, mobile phones, vehicles, and stationary device, but its use is not limited to them. In particular, it is especially suitable as a case for batteries.

It should be understood that the terms and expressions used herein are used for explanation and have no intention to be used to construe in a limited manner, do not eliminate any equivalents of features shown and mentioned herein, and allow various modifications falling within the claimed scope of the present invention.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive.

### DESCRIPTION OF THE REFERENCE NUMERALS

1 . . . packaging material
2 . . . heat-resistance resin layer (outer side layer)
3 . . . heat-fusible resin layer (inner side layer)
4 . . . metal foil layer
5 . . . first adhesive layer (outer side adhesive layer)
6 . . . second adhesive layer (inner side adhesive layer)
8 . . . easily adhesive layer
10 . . . case (molded case)
15 . . . exterior material
30 . . . power storage device
31 . . . power storage device main body

1-10. (canceled)

11. A packaging material comprising:
a heat-resistant resin layer as an outer side layer;
a heat-fusible resin layer as an inner side layer; and
a metal foil layer arranged between the heat-resistant resin layer and the heat-fusible resin layer,
wherein the heat-resistant resin layer is made of a heat-resistant resin film having a hot water shrinkage rate of 1.5% to 12%,
wherein the heat-resistant resin layer and the metal foil layer are adhered via an outer side adhesive layer,
wherein the outer side adhesive layer is made of an urethane adhesive agent containing a polyol, a polyfunctional isocyanate compound, and an aliphatic compound having a plurality of functional groups capable of reacting with an isocyanate group in one molecule,
wherein the polyol is any of a polyester polyol, a polyether polyol, a polyester polyurethane polyol and a polyether polyurethane polyol.

12. A packaging material comprising:
a heat-resistant resin layer as an outer side layer;
a heat-fusible resin layer as an inner side layer; and
a metal foil layer arranged between the heat-resistant resin layer and the heat-fusible resin layer,
wherein the heat-resistant resin layer is made of a heat-resistant resin film having a hot water shrinkage rate of 1.5% to 12%,
wherein the heat-resistant resin layer and the metal foil layer are adhered via an outer side adhesive layer,
wherein the outer side adhesive layer is made of an urethane adhesive agent containing a polyol, a polyfunctional isocyanate compound, and an aliphatic compound having a plurality of functional groups capable of reacting with an isocyanate group in one molecule,
wherein a number average molecular weight of the polyol is within a range of 8,000 to 30,000,
wherein a number average molecular weight of the aliphatic compound is smaller than the number average molecular weight of the polyol.

13. The packaging material as recited in claim 11, wherein the polyol is a polyester polyol.

14. The packaging material as recited in claim 13,
wherein the polyester polyol includes a dicarboxylic acid component, and
wherein the dicarboxylic acid component contains an aromatic dicarboxylic acid, and a content rate of the aromatic dicarboxylic acid in the dicarboxylic acid component is 40 mol % to 80 mol %.

15. The packaging material as recited in claim 11,
wherein the aliphatic compound is a polyhydric alcohol.

16. The packaging material as recited in claim 11,
wherein the outer side adhesive layer includes at least one type of bond selected from the group consisting of an urethane bond, an ester bond, an urea bond, an allophanate bond, a burette bond, and an amide bond.

17. The packaging material as recited in claim 11,
wherein an easily adhesive layer is arranged between the heat-resistant resin layer and the outer side adhesive layer.

18. The packaging material as recited in claim 17,
wherein the easily adhesive layer contains one or two or more types of resins selected from the group consisting of an epoxy resin, an urethane resin, an acrylic ester resin, a methacrylic ester resin, and a polyethylenimine resin.

19. The packaging material as recited in claim 11,
wherein a Young's modulus of a cured film of the urethane adhesive agent is 90 MPa to 400 MPa.

20. A case made by a molded body of the packaging material as recited in claim 11.

21. A method for producing a case in which the packaging material as recited in claim 11 is subjected to deep-drawing or bulging.

22. A power storage device including:
a power storage device main body; and
an exterior material consisting of the packaging material as recited in claim 11,
wherein the power storage device main body is armored by the exterior material.
